(19) United States
(12) Patent Application Publication
(10) Pub. No.: US 2022/0090880 A1
(43) Pub. Date: Mar. 24, 2022

(54) FLASHLIGHT LEVER CLAMP

(71) Applicant: Alex Leutzinger, Sparks, NV (US)

(72) Inventor: Alex Leutzinger, Sparks, NV (US)

(21) Appl. No.: 17/031,351

(22) Filed: Sep. 24, 2020

(51) Int. Cl. F41G 11/00; F21V 21/14; F21V 21/088; F21V 23/04; F41G 1/35

(52) U.S. Cl. CPC F41G 11/00; F21V 21/145; F41G 1/35; F21V 23/0421; F21V 21/0885

(57) ABSTRACT

A tubular bodied flashlight may be used on a long-gun or firearm. To enable actuation of a tailcap button of the flashlight in an ergonomic manner, in particular without the operator needing to shift their hands from a firing position on the firearm, a mechanical apparatus may be mounted to the flashlight. The mechanical apparatus may comprise a clamp body for securing the mechanical apparatus to the flashlight and a paddle lever pivotally mounted to the clamp body. The paddle lever is rotatable from an effective position that in use, enables a user to press the paddle lever against the tailcap button to actuate the tailcap button, and a storage position located away from the tailcap button.

### CROSS REFERENCE TO RELATED APPLICATIONS

This application claims priority to U.S. provisional patent application Ser. No. 62/906,618 filed 26 Sep. 2019, the contents of which are herein incorporated by reference

### FIELD OF THE INVENTION

The present invention relates to actuation devices for activating a tactical flashlight, i.e. a flashlight that can be mounted to a firearm, in particular a long-barreled firearm such as a rifle or shotgun.

### BACKGROUND OF THE INVENTION

Flashlights are commonly mounted on military and law enforcement weapons to aid in accurate target identification during low-light conditions by providing the ability to accurately identify and target subjects before engaging them. Because low-light target identification is critical for the safety of police, military, and other firearm users, a weapon-mounted light needs to be easily located and activated.

Tube-body flashlights are commonly mounted on weapons to provide illumination and are mounted parallel to the barrel of the weapon. Long-gun-mounted, tube-body flashlights are commonly activated by pushing an end cap or tail cap button, located on the end of the flashlight's body. The factory placement of the activation button on the end of the flashlight's tailcap, however, is non-ergonomic, or awkward to activate when mounted to a long-gun, because the means of activation requires forward motion of the user's thumb, of which, the same hand is grasping the weapon.

A common solution which makes activation of a tube-body weapon-mounted flashlight more natural and ergonomic, is to replace the flashlight's original button tailcap with a switch that is wired to the flashlight. The switch may be placed in a more ergonomic location on the long-gun. The relocation of the flashlight's activation switch allows the flashlight to be activated by a more ergonomic lateral squeeze motion. There are three problems, however, with the common practice of replacing a flashlight's original button tailcap with a remotely wired switch:

Problem 1: The wires connecting the remote activation switch to the flashlight, can easily be damaged from various things, such as heat, impact, kinking, abrasion and snagging.

Problem 2: If the remotely wired activation switch is damaged, there is no secondary method to activate the light because original button has been replaced.

Problem 3: Some remotely wired tape switches, when installed in place of a flashlight's original tailcap, do not perform all of the functionality that was originally available by way of using the factory-supplied button tailcap.

Accordingly, there is a need for a reliable, non-electronic/electric, mechanical way to activate a tube-body, weapon-mounted flashlight, that offers a less-awkward, more ergonomic actuation method.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to mechanically activate a tailcap switch of a light;

the ability to use lateral pressure to activate a tailcap switch of a light;

the ability to operate a tailcap switch of a light mounted to a firearm while maintaining grip on the firearm;

the ability to operate a tailcap switch of a light by squeeze pressure;

the ability to move an external tailcap button actuator to an ineffective or stored position to enable standard operation of a tailcap button of a flashlight;

the ability to safely store an external tailcap button actuator so that it cannot inadvertently actuate the tailcap button.

These and other advantages may be realized by reference to the remaining portions of the specification, claims, and abstract.

### BRIEF DESCRIPTION OF ONE EMBODIMENT OF THE PRESENT INVENTION

In one aspect of the present invention, a mechanical apparatus is provided that attaches to a tubular-bodied, long-gun-mounted flashlight that affords a user the ability to activate the flashlight's tailcap button. The mechanical apparatus may comprise a clamp body for securing the mechanical apparatus to the flashlight and a paddle lever pivotally mounted to the clamp body. The paddle lever is rotatable from an effective position that in use, enables a user to press the paddle lever against the tailcap button to actuate the tailcap button, and a storage position located away from the tailcap button.

In one aspect of the present invention, there is provided a mechanical apparatus that attaches to a tubular-bodied, long-gun-mounted flashlight which affords a user, the ability to activate the flashlight's tailcap button. The mechanical apparatus may comprise clamp body means for securing the mechanical apparatus to the flashlight, and paddle lever means pivotally mounted to the clamp body means for actuating the tailcap button. The paddle lever means may comprise rotation means for rotating the paddle lever means from an effective position that in use, enables a user to press the paddle lever means against the tailcap button to actuate the tailcap button, and a storage position located away from the tailcap button.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially shows a perspective view of a flashlight body with a prior art level clamp;

FIG. 2 substantially shows the flashlight of FIG. 1 in side view;

FIG. 3 substantially shows a rear perspective view of a lever clamp with retainer in accordance with an embodiment of the present invention in an effective configuration;

FIG. 4 substantially shows a front perspective view of a clamp body;

FIG. 5 substantially shows a rear perspective view of the lever clamp of FIG. 3 in a storage configuration;

FIG. 6 substantially shows a rear perspective of a flashlight with fitted lever clamp and retainer in an effective configuration;

FIG. 7 substantially shows a rear perspective of the flashlight with fitted lever clamp and retainer in a storage configuration;

FIG. 8 substantially shows a side view of a flashlight with fitted lever clamp and retainer in an effective configuration; and

FIG. 9 substantially shows a side view of the flashlight with fitted lever clamp and retainer in a storage configuration.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

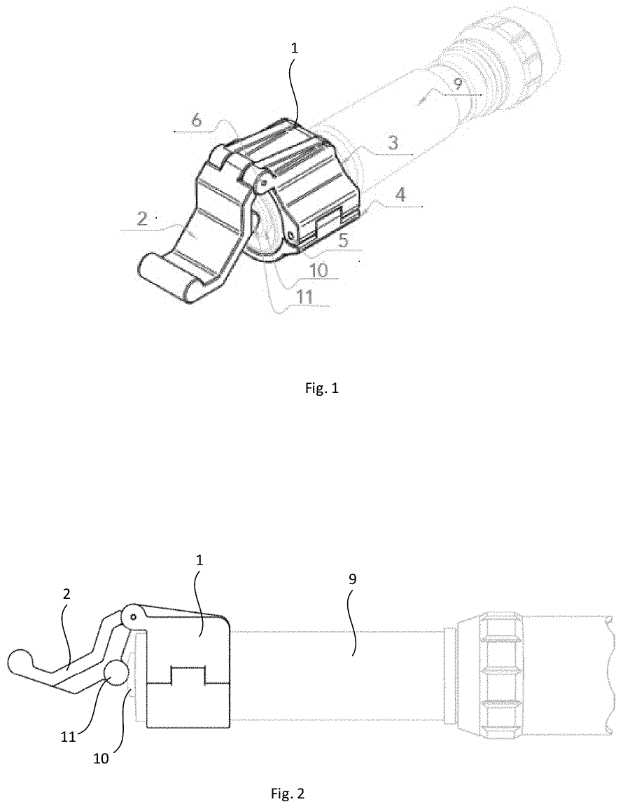

In the present Applicant's co-pending patent application Ser. No. 16/100,140, the entire contents of which are incorporated herein by reference, there is described a mechanical lever that clamps onto the tail cap of a tube-body flashlight and activates the flashlight's tail cap button by squeezing or pressing a lever in an ergonomic direction perpendicular to a longitudinal axis of a body of the flashlight. FIGS. 1 and 2 show the lever clamp 1 secured to the body 2 of a tubular flashlight. Clamping components 3, 4 hinged at hinge 5 secure around the tailcap of the flashlight body 9 to locate a lever in a position adjacent the tailcap button 10 of the flashlight. The lever 2 is pivotally mounted 6 to the clamp body. Ordinarily, the tailcap button 10 is actuated by finger pressure in a forward longitudinal direction with respect to the longitudinal axis of the flashlight body. As described above, this method of actuation can be inconvenient when a user is simultaneously trying to hold and operate a firearm. The lever clamp 2 changes the direction of pressure required to operate the tailcap button from a forward direction to a lateral direction that is perpendicular to the longitudinal axis of the flashlight body. A hammer or similar protrusion 11 on the back side of the lever 2 presses against the tailcap button 10

As was described in the Applicant's co-pending patent application referenced above, the tail clamp includes stoppage surfaces for limiting the range of rotation of the lever clamp so that the lever is always maintained in substantial contact with the tail cap button.

It has been found that limiting the range of rotation can have disadvantages. For example, when storing the firearm with the light and lever clamp in place, the lever may lean against firearms or other devices that inadvertently cause the lever to actuate the tail cap button, causing the batteries of the light to discharge. A further disadvantage is that if the lever clamp fails, the lever cannot be moved sufficiently to provide access to the tail cap button without having to remove the complete clamp assembly. A further disadvantage is that because the lever clamp is simple to operate, requiring only light pressure to actuate the tailcap button, there can be times when the light is inadvertently turned on or turned off, which may create issues in a tactical or operative environment. To overcome or at least ameliorate these disadvantages, an alternative embodiment will be describe herein.

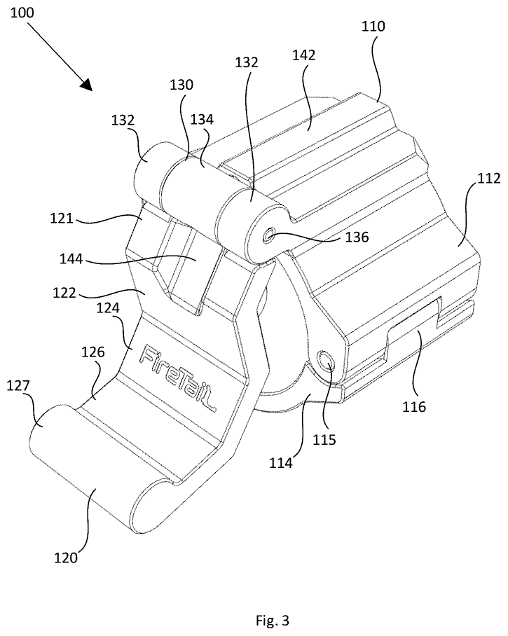

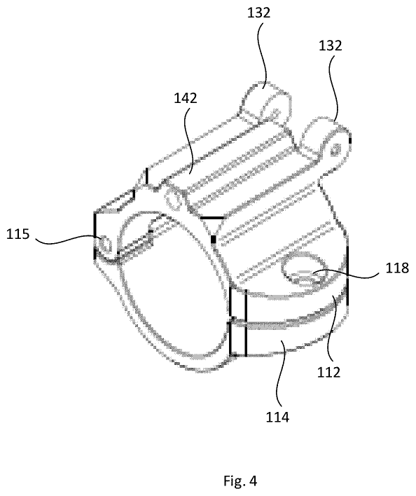

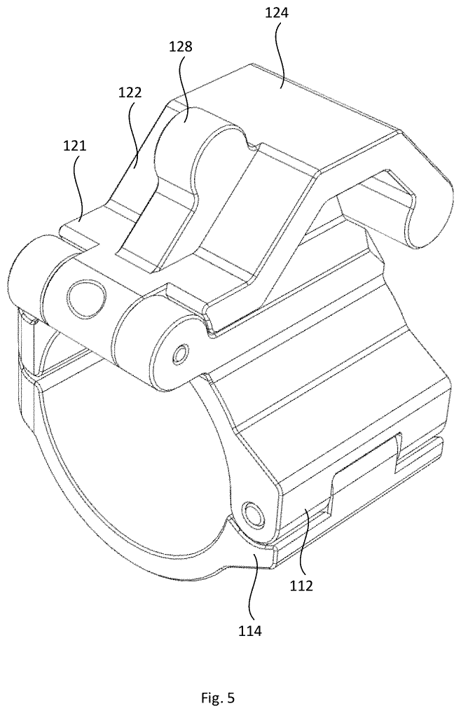

A lever clamp 100 is shown in FIG. 3. The lever clamp has a clamp element 110 and a lever element 120. The clamp element 110 is a clamshell style having an first (upper) clamp component 112 and a second (lower) component 114 that pivot relative to each other on one side on a pin 115 at a hinge 116, creating a clamp force around the tailcap of the flashlight and locking the clamp 110 in place with a lock screw through apertures 118.

A paddle lever 120 attaches to the clamp element at a hinge joint 130 located at a back edge of one of the clamp body components 112 114. In the embodiment depicted, the paddle lever 120 attaches to the upper clamp body 112. The paddle lever is able to move through a range of motion from an effective position (FIG. 3) to an ineffective or storage position (FIG. 5), as will be described in more detail below.

The paddle lever 120 is an angled component having a short hinge extension 121 that extends from the hinge joint 130, a first portion 122 that extends from the hinge extension 121 and, in use in the effective position, lies against the tailcap button of the flashlight. At an end of the first portion 122 opposite the hinge joint end, a second portion 124 extends from the end of the first portion 122 at an angle that is both outward, i.e. backward in the normal orientation of the lever clamp, and further away from the hinge joint 130 (downward in the orientation depicted). A third portion 126 extends from an end of the angle second portion. The third portion, in use in an effective position, lies in a plane that is parallel with the longitudinal axis of the flashlight body. An end of the third portion 126 may include a rounded section 127 that partially defines a cradle with the third portion and second portion so that a user may comfortable locate and nestle a finger or thumb on the paddle lever.

On the forward side of the paddle lever 120, adjacent a junction of the first portion 122 and second portion 124, is a rounded protrusion 128 extending along the width of the paddle lever 120. The protrusion 128 provides a hammer or similar contact point for contacting the tailcap button of the flashlight.

The paddle hinge joint 130 is located at a rearward edge of the clamp body 112.

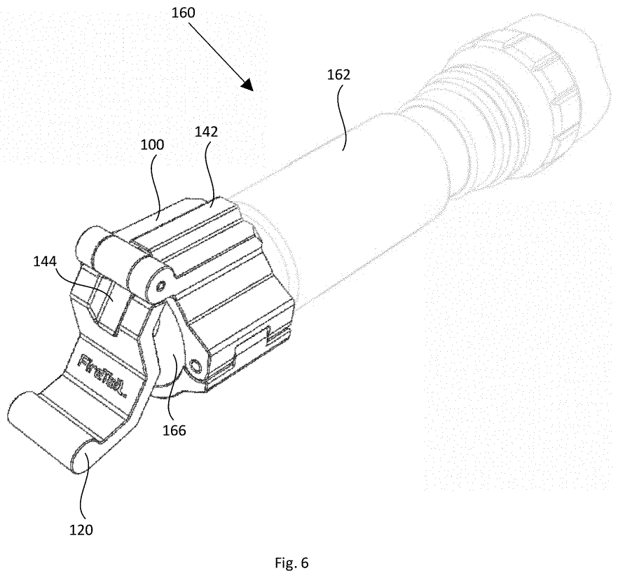

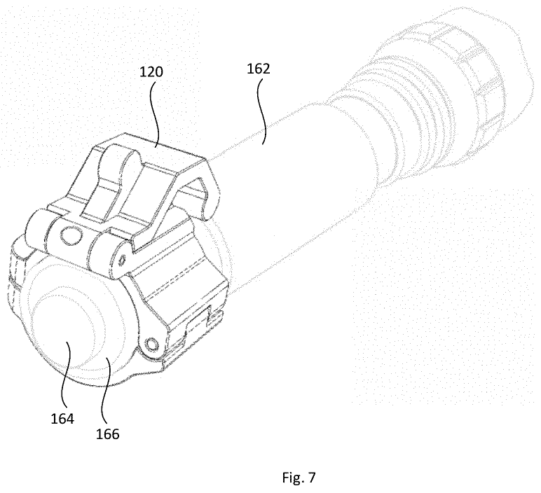

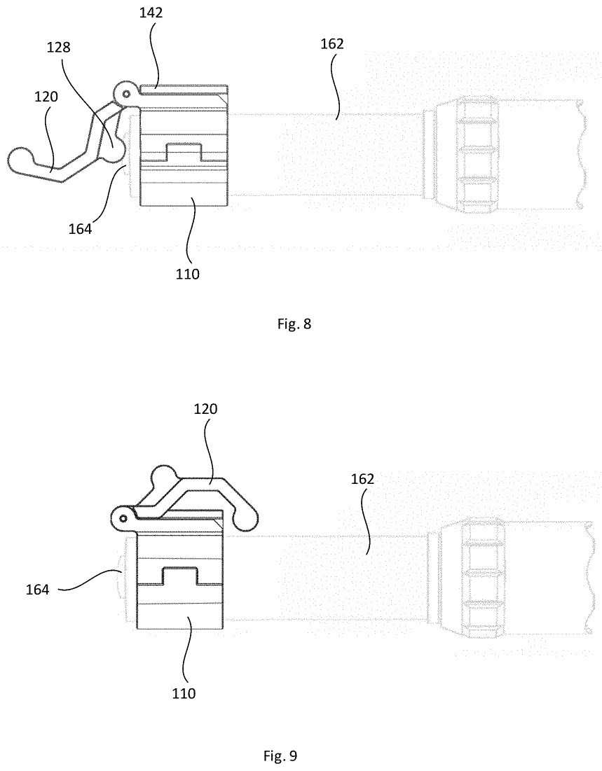

The hinge joint 130 comprises two outer hinge elements 132 that extend backward, relative to the longitudinal direction of the flashlight body when the lever clamp is in use, of the upper clamp component 112. The paddle lever 120 includes a central hinge element 134 that is received between the outer hinge elements 132. A hinge pin 136 passing through all of the hinge elements 132, 134 secures the hinge 130. The paddle lever 120 is thus able to pivot on the hinge pin 136 to sweep through a rotational range of motion. The lever clamp 100 is shown attached to the body 162 of a flashlight 160 in FIGS. 6 to 9. The rotational range of motion extends from an effective position (FIGS. 6 and 8), in which the paddle lever 120 is located in substantial contact with the tailcap button 164 at the rear end 166 of the flashlight to enable pressure applied to the paddle lever 120 to actuate the tailcap, to an ineffective position or storage position. In the storage position, the paddle lever 120 is located away from the tailcap button. In various embodiments, when the paddle lever is located in the storage position, there is unhindered access to the tailcap button of the flashlight and the paddle lever cannot be used to effect actuation of the tailcap button.

In one embodiment, the paddle hinge 130 allows the paddle lever 120 to rotate from the effective position through at least 180 degrees. In one embodiment, the paddle lever is rotatable through approximately 270 degrees so that the paddle lever 120 rests against an outer surface of the clamp body. In one embodiment the first clamp component has a longitudinal ridge or rib 142 disposed in alignment with the gap between the two outer hinge elements 132. The paddle lever 120 has a corresponding channel 144 in the rearward outer surface, e.g. in the hinge extension 121. As the paddle lever 120 is rotated from the effective position to the storage position, the rib 142 is accommodated within the channel 144. Additional retention mechanisms, such as clips or retention ridges may be provided so that the paddle lever 120 can be maintained in the storage position and will not inadvertently return to the effective position, e.g. whilst the firearm is being transported.

The paddle lever hinge 130 is located on the rearward edge of the clamp body so that, in use, the lever hinge is located to a lateral side of the tailcap body (i.e., to the left, right, above, or below) rather than being immediately behind the tailcap button in the longitudinal direction. In the particular embodiments depicted, the lever hinge 130 is located above the tailcap body 166. The paddle lever extends from this hinge across the tail cap button to the rounded portion 127 at the distal end of the third portion 126 of the paddle lever 120. By having the hinge 130 located to the side of the tailcap button and having the paddle lever 120 extend across the tailcap button, substantial leverage can be created by the user applying lateral pressure on the paddle lever, e.g. at the third portion which is approximately perpendicular to the first portion and to the tailcap button.

By allowing the paddle lever to be rotated from the effective position into a storage position, several additional benefits may be achieved. In the storage position, the light switch will not be easily inadvertently toggled while the firearm is stored.

There may also be reasons to prevent toggling of the light switch during use. For example, if the light is off, the user may wish to avoid toggling the light on and risk revealing the user's position. Alternatively, the light may be on and the user may not wish to risk the light toggling off while the user is attempting to shoot. The full range of the paddle lever 120 allows the user to select whether the paddle lever is located in its effective position or in a storage position which cannot affect the button 164.

The user can also move the paddle lever 120 out of its effective position in the event of some failure so that the user can readily access the tailcap button of the flashlight in its standard manner.

The configuration of the paddle lever, allowing lateral pressure to be used to actuate the tailcap button, allows the flashlight to be mounted and actuated in a range of positions on the firearm, depending on the user's ergonomic preference. The flashlight may be mounted on the top, underneath, left or right of the firearm. In any of these positions, the paddle lever may be accessible to the user.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A mechanical apparatus that attaches to a tubular-bodied, long-gun-mounted flashlight which affords a user, the ability to activate the flashlight's tailcap button, the mechanical apparatus comprising:
(A) a clamp body for securing the mechanical apparatus to the flashlight; and
(B) a paddle lever pivotally mounted to the clamp body, wherein the paddle lever is rotatable from an effective position that in use, enables a user to press the paddle lever against the tailcap button to actuate the tailcap button, and a storage position located away from the tailcap button.

2. The mechanical apparatus of claim 1 wherein, when the paddle lever is located in the storage position, there can be unhindered access to the tailcap button.

3. The mechanical apparatus of claim 1 wherein, when the paddle lever is located in the storage position, the paddle lever cannot be used to actuate the tailcap button.

4. The mechanical apparatus of claim 1 wherein the paddle lever is rotatable through at least 180 degrees.

5. The mechanical apparatus of claim 1 wherein the paddle lever is rotatable through 270 degrees.

6. The mechanical apparatus of claim 1 wherein, in the storage position, the paddle lever rests against an outer surface of the clamp body.

7. The mechanical apparatus of claim 1 comprising one or more retention mechanisms for retaining the paddle lever in the storage position.

8. The mechanical apparatus of claim 1 wherein the paddle lever is mounted to the clamp body at a hinge joint, wherein the hinge joint is disposed so that, in use, the hinge joint is located to one lateral side of the tailcap button.

9. The mechanical apparatus of claim 1 wherein the paddle lever comprises an angled element comprising a first portion that, in use in the effective position, lies adjacent the tailcap button and at least one further portion that, in use in the effective position, extends rearward of the first portion and lies in a plane parallel to a longitudinal axis of a body of the flashlight.

10. A mechanical apparatus that attaches to a tubular-bodied, long-gun-mounted flashlight which affords a user, the ability to activate the flashlight's tailcap button, the mechanical apparatus comprising:
(A) clamp body means for securing the mechanical apparatus to the flashlight; and
(B) paddle lever means pivotally mounted to the clamp body means for actuating the tailcap button, wherein the paddle lever means comprises rotation means for rotating the paddle lever means from an effective position that in use, enables a user to press the paddle lever means against the tailcap button to actuate the tailcap button, and a storage position located away from the tailcap button.

11. The mechanical apparatus of claim 1 wherein, when the paddle lever means is located in the storage position, there can be unhindered access to the tailcap button.

12. The mechanical apparatus of claim 1 wherein, when the paddle lever means is located in the storage position, the paddle lever means cannot be used to actuate the tailcap button.

13. The mechanical apparatus of claim 1 wherein the paddle lever means is rotatable through at least 180 degrees.

14. The mechanical apparatus of claim 1 wherein the paddle lever means is rotatable through 270 degrees.

15. The mechanical apparatus of claim 1 wherein, in the storage position, the paddle lever means rests against an outer surface of the clamp body means.

16. The mechanical apparatus of claim 1 comprising one or more retention means for retaining the paddle lever means in the storage position.

17. The mechanical apparatus of claim 1 wherein the paddle lever means is mounted to the clamp body means at a hinge joint, wherein the hinge joint is disposed so that, in use, the hinge joint is located to one lateral side of the tailcap button.

18. The mechanical apparatus of claim 1 wherein the paddle lever means comprises an angled element comprising a first portion that, in use in the effective position, lies adjacent the tailcap button and at least one further portion that, in use in the effective position, extends rearward of the first portion and lies in a plane parallel to a longitudinal axis of a body of the flashlight.
